(19) United States
(12) Patent Application Publication
(10) Pub. No.: US 2008/0229808 A1
(43) Pub. Date: Sep. 25, 2008

(54) Device capable of automatically ejecting testing strip

(75) Inventor: Chi-Nan Lee, Hsinchu (TW)

Correspondence Address: Joe McKinney Muncy, PO Box 1364, Fairfax, VA, 22038-1364, US

(73) Assignee: EPS Bio Technology Corp.

(21) Appl. No.: 11/723,711

(22) Filed: Mar. 21, 2007

(51) Int. Cl. B01L 11/00

(52) U.S. Cl. 73/61.41

(57) ABSTRACT

A biosensing device capable of automatically ejecting a testing strip is disclosed. The biosensing device includes: a measuring circuit, for measuring a sample of the testing strip to generate a measurement result; and a solenoid, having a moveable part, the moveable part being directly or indirectly connected to the testing strip, the solenoid being utilized for moving the moveable part to eject the testing strip from the biosensing device through a movement of the moveable part.

### BACKGROUND OF THE INVENTION

1. Field of the Invention

The present invention relates to a biosensing device, and more particularly, to a biosensing device capable of automatically ejecting a testing strip.

2. Description of the Related Art

In general, a biosensing device is utilized to measure the concentration of biological materials (for example, blood glucose concentration) in humans' blood. Therefore, a diabetic can monitor his blood glucose concentration by using the biosensing device to take care his health.

Taking a blood glucose measurement as an example here, when the biosensing device is utilized, the user has to firstly insert a testing strip corresponding to the blood glucose measurement, obtains a sample (e.g.: in this case, the sample is the blood of the user), and then drop the blood on the testing strip. In this way, the biosensing device can measure the blood glucose concentration of the blood according to the electronic properties of the blood on the testing strip. Therefore, the user can read the blood glucose concentration from the display of the biosensing device.

In addition, when the measurement operation is finished, since the testing strip cannot be reused, the user has to eject the testing strip from the biosensing device, and destroys or burns the used testing strip to prevent the sample from polluting the environment.

However, the ejecting mechanism of the biosensing device is not good. In general, the user may have to pull out the testing strip from the biosensing device by hands. Or, the user may have to use some mechanical mechanisms to eject the testing strip. Please note that, in the above-mentioned ejecting mechanism, the user needs to perform some mechanical operations by hands, and therefore touch the testing strip. This means that the user's hand may be polluted by the sample because of the contact.

From the above disclosure, it can be seen that the ejecting mechanism is not perfect. Especially when the biosensing device is utilized in a medical institution, people who work in the medical institution may touch the blood samples and be infected by some terrible diseases.

### SUMMARY OF THE INVENTION

Therefore, an object of the claimed invention is to provide a biosensing device capable of automatically ejecting the testing strip to prevent the user from being polluted by the blood sample, to further solve the problems of the prior art.

According to an embodiment of the present invention, a biosensing device capable of automatically ejecting a testing strip is disclosed. The biosensing device comprises: a measuring circuit, for measuring a sample of the testing strip to generate a measurement result; and a solenoid, having a moveable part, the moveable part being directly or indirectly connected to the testing strip, the solenoid being utilized for moving the moveable part to eject the testing strip from the biosensing device through a movement of the moveable part.

According to another embodiment of the present invention, a biosensing device capable of automatically ejecting a testing strip is disclosed. The biosensing device comprises: a measuring circuit, for measuring a sample of the testing strip to generate a measurement result; and a motor, having a moveable part, the moveable part being directly or indirectly connected to the testing strip, the motor being utilized for moving the moveable part to eject the testing strip from the biosensing device through a movement of the moveable part.

The present invention biosensing device has an electronic mechanism to automatically eject the testing strip. Therefore, the user does not have to directly eject the testing strip by hands. This reduces the possibility of touching the blood sample when ejecting the testing strip, and makes the biosensing device more convenient.

### BRIEF DESCRIPTION OF THE DRAWINGS

FIG. 1 is a diagram showing a biosensing device 100 having an inserted testing strip 160 according to the present invention.

FIG. 2 is a diagram showing the biosensing device ejecting the testing strip according to the present invention.

### DETAILED DESCRIPTION OF THE INVENTION

The “biosensing device capable of automatically ejecting testing strip” of the invention will be described with reference to the accompanying drawings.

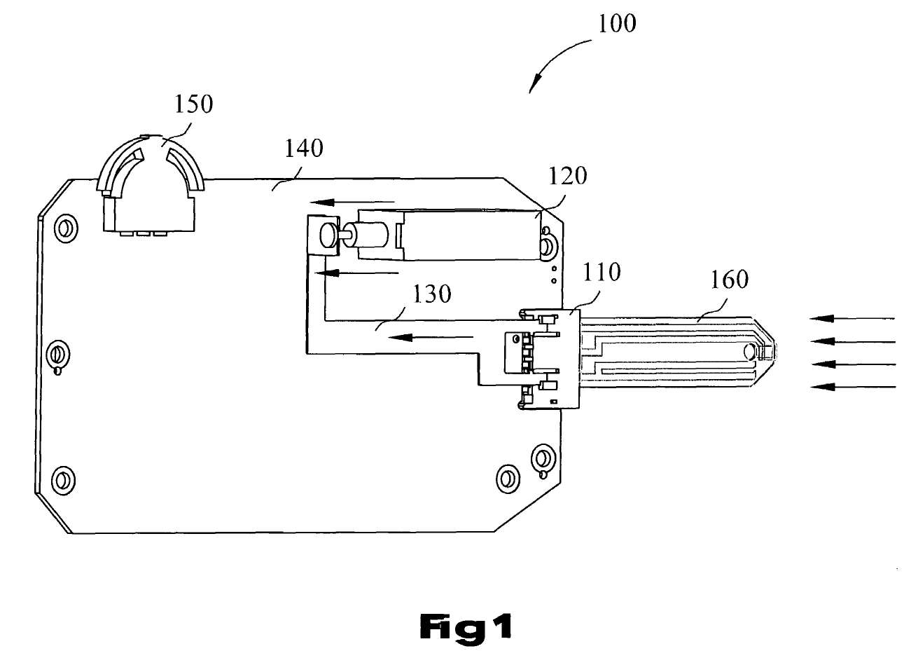

Please refer to FIG. 1, which is a diagram showing a biosensing device 100 having an inserted testing strip 160 according to the present invention. Please note that, in order to illustrate the mechanism easily, the biosensing device 100 shown in FIG. 1 mainly focuses on the inner structure, and the outer housing and the display device are therefore omitted.

As shown in FIG. 1, the biosensing device comprises a testing strip connector 110, a solenoid 120, a connective piece 130, a circuit board 140, and a button 150. In this embodiment, the button 150 is utilized as a control device. This means that the user can control the functions of the biosensing device 100 through using the button 150.

On the other hand, the circuit board 140 comprises some measurement circuits for supporting the above-mentioned measurement function (for example, it can support the blood glucose measurement) to measure the sample on the testing strip 160. Please note that, the above-mentioned measurement circuits and the button 150 are similar to those built in a conventional biosensing device, and further illustration is thus omitted here.

The difference between the biosensing device 100 and the conventional biosensing device is: the present invention biosensing device 100 has a new function of automatically ejecting the testing strip 160.

The above-mentioned function is mainly implemented by the solenoid 120 and the connective piece 130. As shown in FIG. 1, the solenoid 120 comprises a pin. Basically, the pin is a moveable part of the solenoid 120, and a string is placed between pin and the main body of the solenoid 120. Therefore, the solenoid 120 is able to make the pin move into the main body or move out from the main body.

On the other hand, in this embodiment, the connective piece 130 is utilized as a gearing device. As shown in FIG. 1, the pin of the solenoid 120 and the connective piece 130 are connected to each other. Therefore, the connective piece 130 moves along with the pin of the solenoid 120.

The operation of the biosensing device 100 is illustrated as follows:

First of all, the user should insert the testing strip 160 into the testing strip connector 110 to establish the electrical connection between the testing strip 160 and the testing strip connector 110. In this way, the measurement circuit on the circuit board 140 can perform a measurement operation on the testing strip 160 through the testing strip connector 110.

At this time, as shown in FIG. 1, when the testing strip 160 is inserted into the testing strip connector 110, the testing strip 160 touches connective piece 130. Therefore, the connective piece 130 moves in the direction as indicated by arrows, and this makes the pin also move out from the main body of the solenoid 120 as indicated by arrows.

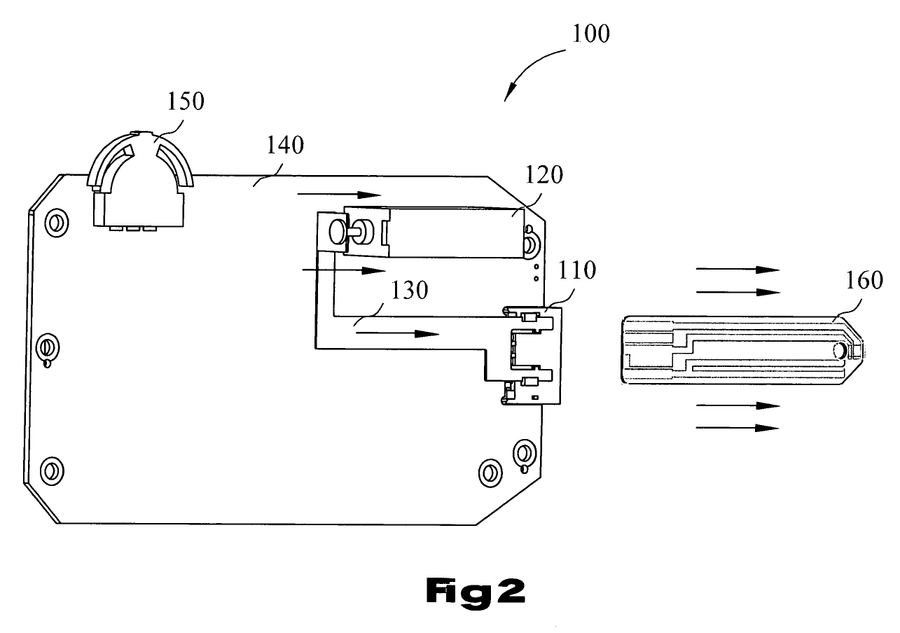

Please refer to FIG. 2, which is a diagram showing the biosensing device 100 ejecting the testing strip 160 according to the present invention. As mentioned previously, after the user finishes using the biosensing device 100, the user has to eject the testing strip 160 from the biosensing device 100. However, please note that, the present invention biosensing device 100 ejects the testing strip 160 through using the solenoid 120.

In this embodiment, in the ejecting procedure, the solenoid 120 starts to work to make the pin move into the main body (as indicated as arrows). As mentioned previously, the pin and the connective piece 130 are connected to each other, therefore, the connective piece 130 also moves along with the pin of the solenoid 120. In this way, the testing strip 160 is pushed out from the testing strip connector 110 by the connective piece such that the ejection operation is completed.

Please note, the aforementioned ejection mechanism is not hard for one skilled in the art. For example, the above-mentioned solenoid 120 can be electrically connected to the circuit board 140. Therefore, the control circuit of the solenoid 120 can be integrated with the measurement circuit. In other words, the original measurement function can be integrated with the above-mentioned ejection function. In this way, the user can use the button 150 to control the ejection operation.

For example, the present invention can utilize the button 150 to trigger an ejection signal. When the solenoid 120 receives the ejection signal, the solenoid 120 starts to move the pin into the main body of the solenoid 120 such that testing strip 160 is ejected through the connective piece 130.

From the above disclosure, it can be seen that the user does not have to directly eject the testing strip 160 by hands or perform additional mechanical operation to eject the testing strip 160 because the user uses the same button 150 to perform the measurement operation and the ejection operation. Therefore, the user does not have to touch the testing strip 160 and will not be polluted by the blood sample. In addition, because the user only needs to use the same button 150 to perform all operations, this makes the biosensing device 100 more convenient.

Please note, the above-mentioned mechanism is only an embodiment, not a limitation of the present invention. In the actual implementation, the present invention is not limited to use a same button. In another embodiment, the present invention can use an additional dedicated button for the ejection operation.

Even, the ejection operation can be performed without involving any button. For example, the biosensing device 100 can be designed as: after finishing the measurement operation (maybe a few second later the complete of the measurement operation), the biosensing device 100 automatically controls the solenoid 120 to eject the testing strip 160. This change also obeys the spirit of the present invention.

In addition, in the above-mentioned embodiment, the gearing device is embodied by the connective piece. However, in the actual implementation, the present invention can utilize other gearing devices to transfer power for ejecting the testing strip. The connective piece is only an embodiment, not a limitation of the present invention. In addition, because the gearing device is used to transfer power to the testing strip 160, in the actual implementation, the present invention does not necessarily need the gearing device. In other words, the gearing device is an optional device. For example, the pin of the solenoid 120 can directly touch the testing strip 160. In this way, the present invention can directly use the pin to push the testing strip 160 without the gearing device.

Please note, in the above-mentioned embodiment, the present invention utilize the solenoid 120 as the power provider of the ejection mechanism. However, the solenoid 120 is an embodiment, not a limitation of the present invention. In the actual implementation, the present invention can utilize other electronic devices as the power provider of the ejection mechanism. For example, the present invention can utilize a motor as the power provider to push the connective piece 130. Because the mechanism using the motor is almost the same as the mechanism using the solenoid, one skilled in the art can easily use the motor to replace the solenoid 120. The further illustration is this omitted here.

In contrast to the prior art, the present invention biosensing device has an electronic mechanism to automatically eject the testing strip. Therefore, the user does not have to directly eject the testing strip by hands. This reduces the possibility of touching the blood sample when ejecting the testing strip, and makes the biosensing device more convenient.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A biosensing device capable of automatically ejecting a testing strip, the biosensing device comprising:
a measuring circuit, for measuring a sample of the testing strip to generate a measurement result; and
a solenoid, having a moveable part, the moveable part being directly or indirectly connected to the testing strip, the solenoid being utilized for moving the moveable part to eject the testing strip from the biosensing device through a movement of the moveable part.

2. The biosensing device of claim 1, further comprising:
a gearing device, having a first end and a second end, the first end touching the testing strip, and the second end connected to the moveable part of the solenoid;
wherein when the moveable part moves, the gearing device moves along with the movable part to eject the testing strip from the biosensing device.

3. The biosensing device of claim 2, wherein the gearing device is a connective piece.

4. The biosensing device of claim 1, further comprising:
a control device, for triggering an ejection signal;
wherein the solenoid is electrically connected to the control device for moving the moveable part after receiving the ejection signal to eject the testing strip from the biosensing device.

5. The biosensing device of claim 4, wherein the control device is a button.

6. The biosensing device of claim 4, further comprising:
a gearing device, having a first end and a second end, the first end touching the testing strip, and the second end connected to the moveable part of the solenoid;
wherein when the moveable part moves, the gearing device moves along with the movable part to eject the testing strip from the biosensing device.

7. The biosensing device of claim 6, wherein the gearing device is a connective piece.

8. A biosensing device capable of automatically ejecting a testing strip, the biosensing device comprising:
a measuring circuit, for measuring a sample of the testing strip to generate a measurement result; and
a motor, having a moveable part, the moveable part being directly or indirectly connected to the testing strip, the motor being utilized for moving the moveable part to eject the testing strip from the biosensing device through a movement of the moveable part.

9. The biosensing device of claim 1, further comprising:
a gearing device, having a first end and a second end, the first end touching the testing strip, and the second end connected to the moveable part of the motor;
wherein when the moveable part moves, the gearing device moves along with the movable part to eject the testing strip from the biosensing device.

10. The biosensing device of claim 2, wherein the gearing device is a connective piece.

11. The biosensing device of claim 1, further comprising:
a control device, for triggering an ejection signal;
wherein the motor is electrically connected to the control device for moving the moveable part after receiving the ejection signal to eject the testing strip from the biosensing device.

12. The biosensing device of claim 4, wherein the control device is a button.

13. The biosensing device of claim 4, further comprising:
a gearing device, having a first end and a second end, the first end touching the testing strip, and the second end connected to the moveable part of the motor;
wherein when the moveable part moves, the gearing device moves along with the movable part to eject the testing strip from the biosensing device.

14. The biosensing device of claim 6, wherein the gearing device is a connective piece.
